(19) United States
(12) Patent Application Publication
(10) Pub. No.: US 2021/0234310 A1
(43) Pub. Date: Jul. 29, 2021

(54) ELECTRICAL CONTACT HAVING A FLEXIBLE CONTACT TAIL

(71) Applicant: TE Connectivity Services GmbH, Schaffhausen (CH)

(72) Inventors: Charles Raymond Gingrich, III, Mechanicsburg, PA (US); Graham Harry Smith, JR., Mechanicsburg, PA (US); Mitchell Kunane Storry, Harrisburg, PA (US)

(21) Appl. No.: 16/751,353

(22) Filed: Jan. 24, 2020

(51) Int. Cl. H01R 13/6474; H01R 13/11; H01R 12/57; H01R 12/71

(52) U.S. Cl. CPC H01R 13/6474; H01R 12/716; H01R 12/57; H01R 13/114

(57) ABSTRACT

An electrical contact includes a main body extending along a longitudinal axis between a mating end and a terminating end of the socket contact. The main body has a first side, a second side, a front, and a rear. The electrical contact includes a mating contact extending from the main body at the mating end including a mating interface configured for mating with a mating electrical contact. The electrical contact includes a contact tail extending from the main body at the terminating end. The contact tail includes a foot configured to be terminated to a circuit board, a neck extending between the foot and the main body that is narrower than the main body, and an impedance control tab extending along the neck for impedance control of the contact tail between the main body and the circuit board

### BACKGROUND OF THE INVENTION

The subject matter herein relates generally to contacts for electrical connectors.

Electrical connectors are used to electrically connect a circuit board or a cable assembly with another circuit board or cable assembly. The electrical connectors typically include electrical contacts that are mated to form electrical circuits between the circuit boards and/or the cable assemblies. For example, the electrical contacts may include socket contacts and pin contacts that are mated. Some known electrical contacts have deflectable mating beams having mating interfaces. However, the electrical contacts are subject to mechanical shock and vibration and may be subject to thermal expansion and contraction. Such shock, vibration and expansion/contraction may stress the mating beams and stress the solder joints over time causing the mating beams to fail. Some known electrical contacts have flexible contact tails to accommodate for the shock, vibration and expansion/contraction. However, the contact tails are typically necked down regions, leading to impedance mismatch with adjacent electrical contacts along the necked regions of the electrical contacts.

A need remains for electrical contacts having flexible contact tails with improved electrical performance over conventional electrical contacts.

### BRIEF DESCRIPTION OF THE INVENTION

In one embodiment, an electrical contact is provided including a main body extending along a longitudinal axis between a mating end and a terminating end of the socket contact. The main body has a first side, a second side, a front, and a rear. The electrical contact includes a mating contact extending from the main body at the mating end including a mating interface configured for mating with a mating electrical contact. The electrical contact includes a contact tail extending from the main body at the terminating end. The contact tail includes a foot configured to be terminated to a circuit board, a neck extending between the foot and the main body that is narrower than the main body, and an impedance control tab extending along or adjacent to the neck for impedance control of the contact tail between the main body and the circuit board.

In an embodiment, an electrical contact is provided including a main body extending along a longitudinal axis between a mating end and a terminating end of the socket contact. The main body has a first side and a second side with a main body width defined between the first side and the second side. The main body has a front and a rear extending between the first side and the second side and a bottom between the first side and the second side. The electrical contact includes a mating contact extending from the main body at the mating end including a mating interface configured for mating with a mating electrical contact. The electrical contact includes a contact tail positioned below the bottom of the main body. The contact tail includes a foot configured to be terminated to a circuit board and a neck extending between the foot and the bottom of the main body. The neck has a first neck side and a second neck side and a neck width narrower than the main body width between the first side and the second side. The contact tail includes an impedance control tab positioned between the bottom of the main body and the circuit board, such as between the bottom of the main body and the foot. The impedance control tab extends along the neck for impedance control of the contact tail between the main body and the circuit board.

In an embodiment, an electrical connector is provided including a housing having a mating end and mounting end. The mating end is mated with a mating electrical connector. The mounting end is mounted to a circuit board. The housing has contact channels between the mating end and the mounting end. The electrical connector includes socket contacts coupled to the housing received in corresponding contact channels. Each socket contact includes a main body extending along a longitudinal axis between a mating end and a terminating end of the socket contact. The main body has a first side, a second side, a front, and a rear. The electrical contact includes a mating contact extending from the main body at the mating end including a mating interface configured for mating with a mating electrical contact. The electrical contact includes a contact tail extending from the main body at the terminating end. The contact tail includes a foot configured to be terminated to a circuit board, a neck extending between the foot and the main body that is narrower than the main body, and an impedance control tab extending along the neck for impedance control of the contact tail between the main body and the circuit board.

### BRIEF DESCRIPTION OF THE DRAWINGS

FIG. 1 illustrates a connector system including electrical connectors having electrical contacts in accordance with an exemplary embodiment.

FIG. 2 is a perspective view of a portion of the electrical connector showing electrical contacts in accordance with an exemplary embodiment.

FIG. 3 is a perspective view of portions of the electrical connectors showing the electrical contacts poised for mating.

FIG. 4 illustrates contact tails of a pair of the electrical contacts.

FIG. 5 illustrates the contact tails of the electrical contacts in accordance with an exemplary embodiment.

FIG. 6 illustrates the contact tails of the electrical contacts in accordance with an exemplary embodiment.

FIG. 7 illustrates the contact tails of the electrical contacts in accordance with an exemplary embodiment.

### DETAILED DESCRIPTION OF THE INVENTION

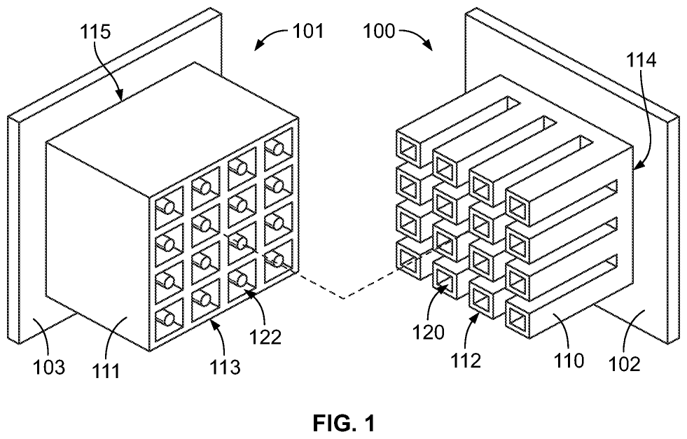

FIG. 1 illustrates a connector system including electrical connectors having electrical contacts configured to be mated in a mating direction in accordance with an exemplary embodiment. The connector system includes an electrical connector 100 having electrical contacts, which may be mounted to a circuit board 102. The electrical connector 100 is configured to be mated to an electrical connector 101 having electrical contacts. In various embodiments, the first electrical connector 100 may be a socket connector and the second electrical connector 101 may be a plug connector. In various embodiments, the second electrical connector 101 is a board mounted connector mounted to a circuit board 103 to form a board-to-board or mezzanine electrical connection. In other various embodiments, the first electrical connector 100 or the second electrical connector 101 is a cabled connector to form a wire-to-board electrical connection.

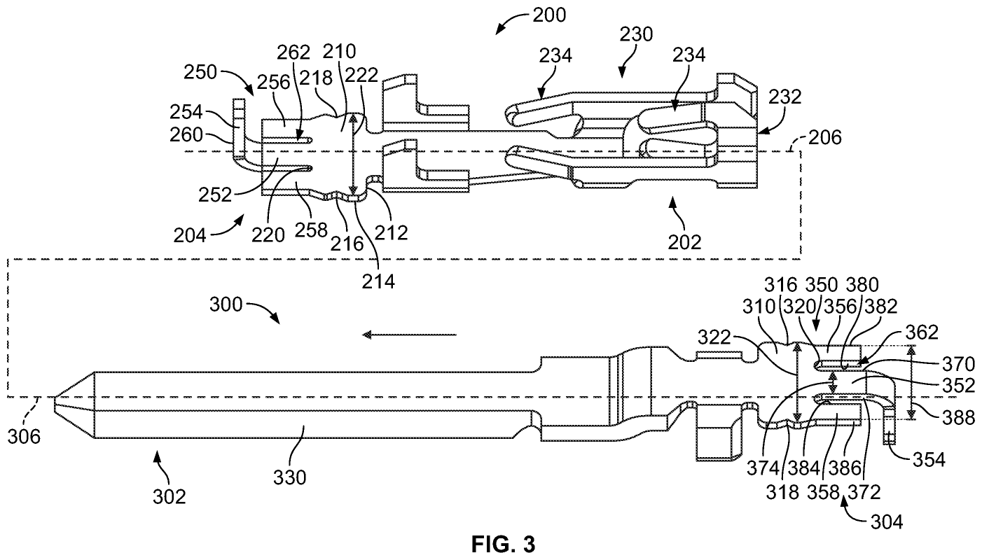

The electrical connector 100 includes a housing 110 having a mating end 112 and a mounting end 114. The mounting end 114 is configured to be mounted to the circuit board 102, such as using mounting hardware. The mating end 112 is configured to be mated with the mating electrical connector 101. The housing 110 includes a plurality of contact channels 120 extending between the mating end 112 and the mounting end 114. In an exemplary embodiment, socket contacts 200 (shown in FIG. 3) are received in corresponding contact channels 120. The socket contacts 200 are configured to be mated with the second electrical connector 101, such as to pin contacts 300 (shown in FIG. 3) of the second electrical connector 101. In alternative embodiments, the first electrical connector 100 includes the pin contacts 300 (or other types of contacts) and the second electrical connector 101 includes the socket contacts 200 (or other types of contacts). The socket contacts 200 are configured to be terminated to the circuit board 102 at the mounting end 114. For example, the socket contacts 200 may be soldered to the circuit board 102. In other various embodiments, the socket contacts 200 may be press-fit into vias of the circuit board 102. In other various embodiments, the socket contacts 200 may be terminated to ends of wires, such as by a crimp connection.

The electrical connector 101 includes a housing 111 having a mating end 113 and a mounting end 115. The mounting end 115 is configured to be mounted to the circuit board 103, such as using mounting hardware. The mating end 113 is configured to be mated with the mating electrical connector 100. The housing 111 includes a plurality of contact channels 121 extending between the mating end 113 and the mounting end 115. In an exemplary embodiment, the pin contacts 300 (shown in FIG. 3) are received in corresponding contact channels 121. The pin contacts 300 are configured to be mated with the socket contacts 200. The pin contacts 300 are configured to be terminated to the circuit board 103 at the mounting end 115. For example, the pin contacts 300 may be soldered to the circuit board 103. In other various embodiments, the pin contacts 300 may be press-fit into vias of the circuit board 103. In other various embodiments, the pin contacts 300 may be terminated to ends of wires, such as by a crimp connection.

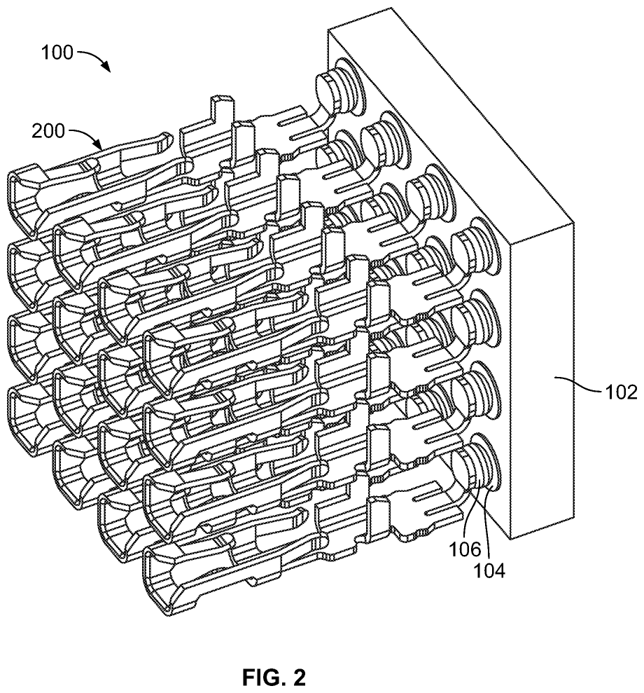

FIG. 2 is a perspective view of a portion of the electrical connector 100 showing the socket contacts 200 terminated to the circuit board 102 with the housing 110 (shown in FIG. 1) removed to illustrate the socket contacts 200. The socket contacts 200 are arranged in an array, such as in a plurality of rows and a plurality of columns. The socket contacts 200 are arranged at a predetermined pitch (for example, a row pitch and a column pitch). Ends of the socket contacts 200 are terminated to the circuit board 102. For example, the ends of the socket contacts 200 form solder pads configured to be soldered to a circuit pad 104 of the circuit board 102 using a solder ball 106.

FIG. 3 is a perspective view of portions of the electrical connectors 100, 101 showing one of the socket contacts 200 poised for mating with one of the pin contacts 300. The socket contact 200 and the pin contact 300 are configured to be mated in a mating direction, shown by the arrow in FIG. 3.

The socket contact 200 is manufactured from a metal material. For example, the socket contact 200 may be a stamped and formed contact. Each socket contact 200 extends between a mating end 202 and a terminating end 204. The socket contact 200 includes a main body 210 extending along a longitudinal axis 206 between the mating end 202 and the terminating end 204. In various embodiments, the socket contacts 200 may be oriented within the housing 110 (shown in FIG. 1) such that the mating end 202 is at a top of the socket contact 200 and the terminating end 204 is at a bottom of the socket contact 200. The socket contact 200 includes a contact tail 250 at the terminating end 204 and a mating socket 230 at the mating end 202. The contact tail 250 is configured to be terminated to the circuit board 102 (shown in FIG. 1). The mating socket 230 is configured to be mated to the pin contact 300. In an exemplary embodiment, the mating socket 230 includes a receptacle 232 that receives the pin contact 300.

The main body 210 includes a front 212 and a rear 214. The main body 210 includes a first side 216 and a second side 218. The front 212 and the rear 214 extend between the first and second sides 216, 218. The main body 210 includes a bottom 220 extending between the first and second sides 216, 218. Optionally, the first and second sides 216, 218 may be generally parallel to each other. The main body 210 has a main body width 222 between the first side 216 and the second side 218. The main body width 222 may be generally constant along the height of the main body 210. However, the main body width 222 may vary along the height. The contact tail 250 extends from the bottom 220. The first and second sides 216, 218 may be defined by edges of the main body 210, such as cut edges formed during a stamping process. The main body 210 may be generally planar, for example, the front 212 and the rear 214 may be generally planar. However, the main body 210 may have other shapes in alternative embodiments. For example, the main body 210 may include tabs or other features that are stamped and bent out of plane along the first and second sides 216, 218.

The mating socket 230 is stamped and formed to form the receptacle 232. In an exemplary embodiment, the mating socket 230 extends along multiple sides of the receptacle 232. For example, the mating socket 230 may extend along three sides or four sides of the receptacle 232, to interface with multiple side of the pin of the pin contact. In the illustrated embodiment, the mating socket 230 extends along all four sides of the receptacle 232 to enclose the receptacle 232. The mating socket 230 includes a plurality of mating beams 234 extending into the receptacle 232 for mating with the pin contact 300. Each mating beam 234 has a corresponding mating interface for mating with the pin contact 300. As such, the mating socket 230 has a plurality of points of contact with the pin contact 300. In various embodiments, the mating beams 234 may be deflectable mating beams. For example, the mating beams 234 may be deflectable cantilevered beams. The mating beams 234 may be fixed beams that are fixed at both ends and flexible between the fixed ends. The mating beams 234 may have different lengths and/or different fixed points to stagger the locations of the mating interfaces. The mating beams 234 may extend in different directions (for example, downward versus upward) to stagger the locations of the mating interfaces. In alternative embodiments, the mating beams 234 may be embossments, such as fixed protrusions that define mating interfaces. The embossments may be elongated in various embodiments. The embossments may be circular points in other various embodiments. Other types of mating interfaces may be provided in alternative embodiments.

With additional reference to FIG. 4, FIG. 4 illustrates a portion of the electrical connector 100 showing the contact tails 250 of a pair of the socket contacts 200. Each contact tail 250 includes a neck 252 extending from the bottom 220 of the main body 210. The contact tail 250 includes a foot 254 extending from the neck 252. The contact tail 250 includes an impedance control tab 256 extending along the neck 252 between the main body 210 and the foot 254. In the illustrated embodiment, the contact tail 250 includes multiple impedance control tabs, such as the first impedance control tab 256 extending along a first side of the neck 252 and a second impedance control tab 258 extending along a second side of the neck 252. However, the contact tail 250 may include a greater or fewer impedance control tabs in alternative embodiments.

The foot 254 is configured to be terminated to the circuit board 102. In an exemplary embodiment, the foot 254 forms a solder pad 260 configured to be soldered to a circuit pad of the circuit board 102, such as via a solder ball. The foot 254 may be bent out of plane relative to the main body 210 and the neck 252, such as being oriented perpendicular to the neck 252. The foot 254 defines the bottom surface of the socket contact 200. The bottom of the foot 254 may be planar and configured to be oriented parallel to the circuit board 102. The foot 254 may have a width that is wider than the neck 252. The foot 254 may have other forms in alternative embodiments, such as being a compliant pin configured to be press-fit into the circuit board 102 or a crimp barrel configured to be crimped to a wire.

The neck 252 forms a link between the foot 254 and the main body 210. In an exemplary embodiment, the neck 252 is flexible between the foot 254 and the main body 210. For example, the neck 252 allows flexibility during mechanical shock and vibration. The neck 252 is flexible to allow thermal expansion of the socket contact 200. The neck 252 is movable relative to the main body 210. The neck 252 is movable relative to the impedance control tabs 256, 258. In an exemplary embodiment, the neck 252 is separated from the impedance control tabs 256, 258 by gaps 262. The gaps 262 may extend parallel to the longitudinal axis 206. The gap 262 may be formed by stamping the neck 252 from the impedance control tabs 256, 258. In an exemplary embodiment, the neck 252 is flanked on both sides by the impedance control tabs 256, 258. However, the neck 252 may be offset relative to the impedance control tab 256 and/or the impedance control tab 258. The gaps 262 allow the neck 252 to move independent of the impedance control tabs 256, 258.

The neck 252 extends between a first neck side 270 and a second neck side 272. The neck 252 has a neck width 274 between the first and second neck sides 270, 272. The neck width 274 is narrower than the width of the foot 254. The neck width 274 is narrower than the main body width 222. The narrow width of the neck 252 allows the neck 252 to be more flexible than the main body 210. As such, shock, vibration and general movement of the socket contact 200 occurs at the neck 252. The neck 252 is flexible to prevent damage to the interface between the contact tail 250 and the circuit board 102. For example, the neck 252 is flexible to prevent damage to the solder joint between the contact tail 250 and the circuit board 102. The width of the neck 252 affects positioning of the contact tail 250 relative to adjacent contact tails 250 within the electrical connector 102. For example, the necks 252 of adjacent contact tails 250 are spaced further apart from each other than the main bodies 210 o the adjacent contact tails 250, which may affect impedance of the socket contacts 200 in the contact tail regions.

The impedance control tabs 256, 258 are provided in the contact tail region to control impedance of the socket contacts 200. The impedance control tabs 256, 258 may extend from the bottom 220 of the main body 210. However, the impedance control tabs 256, 258 may extend from the neck 252 in alternative embodiments (for example, the gaps 262 may be provided between the bottom 220 of the main body 210 and the impedance control tabs 256, 258). The impedance control tabs 256, 258 extends along the neck 252 to provide impedance control for the socket contact 200 between the main body 210 and the circuit board 102. The impedance control tabs 256, 258 extends between the main body 210 and the foot 254 adjacent to the neck 252. The impedance control tabs 256, 258 may extend substantially an entire height of the contact tail 250 between the circuit board 102 and the bottom 220 of the main body 210. The impedance control tab 256 may be generally coplanar with the neck 252. In various embodiments, the neck 252 and the impedance control tab 256 are coplanar with the main body 210.

The impedance control tab 256 includes an inner side 280 facing the first neck side 270 and an outer side 282 opposite the inner side 280. The impedance control tab 258 includes an inner side 284 facing the second neck side 272 and an outer side 286 opposite the inner side 284. The inner sides 280, 284 face the neck 252 across the gaps 262. In an exemplary embodiment, the outer side 282 may be generally aligned with the first side 216 of the main body 210 and the outer side 286 may be generally aligned with the second side 218 of the main body 210. The impedance control tabs 256, 258 widen the contact tail 250 in the space between the main body 210 and the circuit board 102. In an exemplary embodiment, the neck 252 and the impedance control tabs 256, 258 have a tail width 288 generally equal to the main body width 222 of the main body 210 between the first side 216 and the second side 218. The impedance control tabs 256, 258 may be used to balance or match impedance in the contact tail region compared to the main body region.

As shown in FIG. 4, the contact tails 250 extend from the bottom 220 of the main body 210. The socket contacts 200 are positioned adjacent to each other with a contact spacing 290 between the main bodies 210 of the socket contacts 200. Impedance of the socket contacts 200 is affected by the contact spacing 290.

In an exemplary embodiment, the impedance control tabs 256, 258 are provided in the contact tail region for improved impedance matching in the contact tail region compared to the main body region. For example, the impedance control tabs 256, 258 widen the contact tail 250 such that the tail width 288 is approximately equal to the main body width 222. The necks 252 of the pair of socket contacts 200 are spaced apart from each other by a neck distance 292. The neck distance 292 is greater than the contact spacing 290 between the main bodies 210. The impedance control tabs 256, 258 partially fill the space between the necks 252. The impedance control tabs 256, 258 of the pair of socket contacts 200 are spaced apart from each other by a tab distance 294. The tab distance 294 is narrower than the neck distance 292. In an exemplary embodiment, the tab distance 294 is approximately equal to the contact spacing 290 for impedance matching of the contact tail region and the main body region.

With reference back to FIG. 3, the pin contact 300 is manufactured from a metal material. For example, the pin contact 300 may be a stamped and formed contact. Each pin contact 300 extends between a mating end 302 and a terminating end 304. The pin contact 300 includes a main body 310 extending along a longitudinal axis 306 between the mating end 302 and the terminating end 304. The pin contact 300 includes a contact tail 350 at the terminating end 304 and a pin 330 at the mating end 302. The contact tail 350 is configured to be terminated to the circuit board 103 (shown in FIG. 1). The pin 330 is configured to be received in the receptacle 232 of the socket contact 200. Other types of contacts may be provided in alternative embodiments, such as contacts having other types of mating interfaces.

The main body 310 includes a front 312 and a rear 314. The main body 310 includes a first side 316 and a second side 318. The front 312 and the rear 314 extend between the first and second sides 316, 318. The main body 310 includes a bottom 320 extending between the first and second sides 316, 318. The contact tail 350 extends from the bottom 320. The main body 310 has a main body width 322 between the first side 316 and the second side 318.

The contact tail 350 may be similar to the contact tail 250. The contact tail 350 includes a neck 352 extending from the bottom 320 of the main body 310. The contact tail 350 includes a foot 354 extending from the neck 352. The contact tail 350 includes an impedance control tab 356 extending along the neck 352 between the main body 310 and the foot 354. In the illustrated embodiment, the contact tail 350 includes multiple impedance control tabs, such as the first impedance control tab 356 extending along a first side of the neck 352 and a second impedance control tab 358 extending along a second side of the neck 352. However, the contact tail 350 may include a greater or fewer impedance control tabs in alternative embodiments.

The neck 352 forms a link between the foot 354 and the main body 310. In an exemplary embodiment, the neck 352 is flexible between the foot 354 and the main body 310. For example, the neck 352 allows flexibility during mechanical shock and vibration. The neck 352 is flexible to allow thermal expansion of the pin contact 300. The neck 352 is movable relative to the main body 310. The neck 352 is movable relative to the impedance control tabs 356, 358. In an exemplary embodiment, the neck 352 is separated from the impedance control tabs 356, 358 by gaps 362. The gaps 362 allow the neck 352 to move independent of the impedance control tabs 356, 358.

The neck 352 extends between a first neck side 370 and a second neck side 372. The neck 352 has a neck width 374 between the first and second neck sides 370, 372. The neck width 374 is narrower than the main body width 322. The narrow width of the neck 352 allows the neck 352 to be more flexible than the main body 310. The neck 352 is flexible to prevent damage to the interface between the contact tail 350 and the circuit board 102.

The impedance control tabs 356, 358 are provided in the contact tail region to control impedance of the pin contact 300 between the main body 310 and the circuit board 102. The impedance control tabs 356, 358 may extend substantially an entire height of the contact tail 350 between the circuit board 102 and the bottom 320 of the main body 310. The impedance control tab 356 includes an inner side 380 facing the first neck side 370 and an outer side 382 opposite the inner side 380. The impedance control tab 358 includes an inner side 384 facing the second neck side 372 and an outer side 386 opposite the inner side 384. The inner sides 380, 384 face the neck 352 across the gaps 362. In an exemplary embodiment, the outer side 382 may be generally aligned with the first side 316 of the main body 310 and the outer side 386 may be generally aligned with the second side 318 of the main body 310. The impedance control tabs 356, 358 widen the contact tail 350 in the space between the main body 310 and the circuit board 102. In an exemplary embodiment, the neck 352 and the impedance control tabs 356, 358 have a tail width 388 generally equal to the main body width 322 of the main body 310 between the first side 316 and the second side 318. The impedance control tabs 356, 358 may be used to balance or match impedance in the contact tail region compared to the main body region.

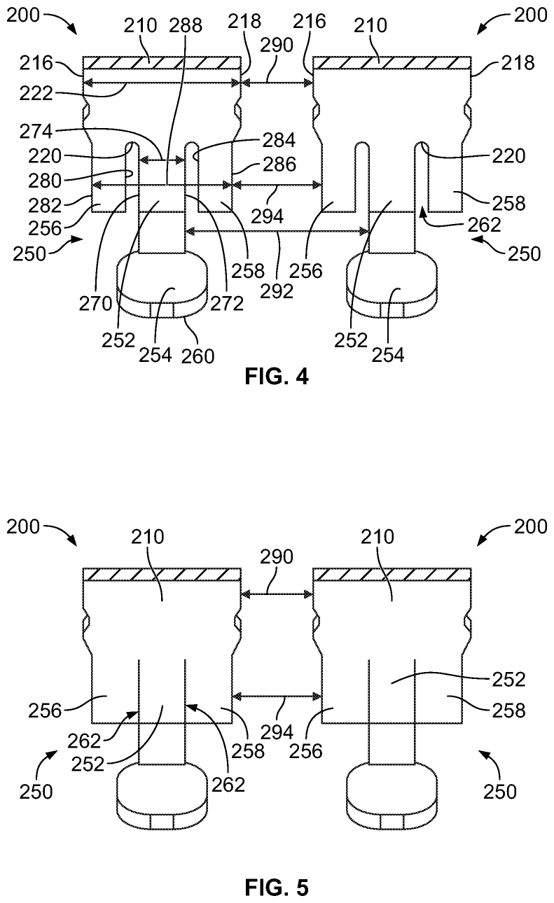

FIG. 5 illustrates the contact tails 250 of the socket contacts 200 in accordance with an exemplary embodiment. The gaps 262 are narrower in the illustrated embodiment compared to the embodiment illustrated in FIG. 4. The gaps 262 are formed by cutting the neck 252 from the impedance control tabs 256, 258 leaving narrow slots forming the gaps 262. The necks 252 are independently movable relative to the impedance control tabs 256, 258. In an exemplary embodiment, the tab distance 294 between the impedance control tabs 256, 258 is approximately equal to the contact spacing 290 between the main bodies 210 for impedance matching of the contact tail region and the main body region.

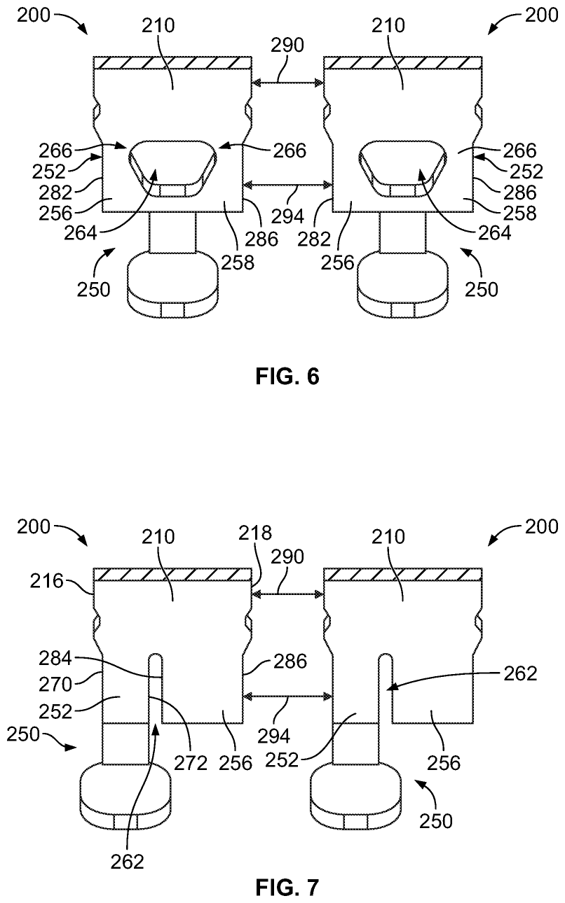

FIG. 6 illustrates the contact tails 250 of the socket contacts 200 in accordance with an exemplary embodiment. In the illustrated embodiment, the neck 252 is shaped differently than the neck 252 in the embodiment illustrated in FIG. 4. The neck 252 includes an opening 264 through the neck 252 rather than the gaps 262 (shown in FIG. 4). The neck 252 completely surrounds the opening 264 with neck segments 266 on both sides of the opening 264 connecting the neck 252 to the main body 210. The neck segments 266 are narrow making the neck 252 flexible and movable relative to the main body 210. The neck segments 266 transition into impedance control tabs 256, 258 on opposite sides of the opening 264. The impedance control tabs 256, 258 have the outer sides 282, 286. In an exemplary embodiment, the tab distance 294 between the outer sides 282, 286 of the impedance control tabs 256, 258 is approximately equal to the contact spacing 290 between the main bodies 210 for impedance matching of the contact tail region and the main body region.

FIG. 7 illustrates the contact tails 250 of the socket contacts 200 in accordance with an exemplary embodiment. The neck 252 of the contact tail 250 is offset toward one side, such as at the first side of the contact tail 250. The contact tail 250 includes a single impedance control tab 258, such as at the second side of the contact tail 250. The contact tail 250 includes a single gap 262 rather than two gaps on both sides of the neck 252 as with the embodiment illustrated in FIG. 4. The neck 252 is off-center relative to the main body 210 with the first neck side 270 is generally aligned with the first side 216 of the main body 210 and the second neck side 272 faces the inner side 284 of the impedance control tab 258. The outer side 286 of the impedance control tab 258 is generally aligned with the second side 218 of the main body 210. In an exemplary embodiment, the tab distance 294 between the outer side 286 of the impedance control tab 258 and the neck 252 is approximately equal to the contact spacing 290 between the main bodies 210 for impedance matching of the contact tail region and the main body region.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

1. An electrical contact comprising:
a main body extending along a longitudinal axis between a mating end and a terminating end of the electrical contact, the main body having a first side and a second side, the main body having a front and a rear extending between the first side and the second side;
a mating contact extending from the main body at the mating end, the mating contact including a mating interface configured for mating with a mating electrical contact; and
a contact tail extending from the main body at the terminating end, the contact tail including a foot configured to be terminated to a circuit board, the contact tail including a neck extending between the foot and the main body, the neck being narrower than the main body between the first side and the second side, the contact tail including an impedance control tab extending along the neck for impedance control of the contact tail between the main body and the circuit board;
wherein the impedance control tab being sized and positioned to balance impedance along the contact tail to a target impedance based on the impedance along the main body.

2. The electrical contact of claim 1, wherein the neck is movable relative to the impedance control tab.

3. The electrical contact of claim 1, wherein the neck is separated from the impedance control tab by a gap, the gap allowing the neck to move independent of the impedance control tab.

4. The electrical contact of claim 1, wherein the main body includes a bottom extending between the first side and the second side, the neck extending from the bottom of the main body to the foot, the impedance control tab extending from the bottom of the main body toward the circuit board.

5. The electrical contact of claim 1, wherein the impedance control tab extends substantially an entire height of the contact tail between the circuit board and a bottom of the main body.

6. The electrical contact of claim 1, wherein the impedance control tab is a first impedance control tab extending along a first side of the neck, the contact tail further comprising a second impedance control tab extending along a second side of the neck.

7. The electrical contact of claim 6, wherein the neck includes a first neck side and a second neck side, the first impedance control tab having a first inner side facing the first neck side, the second impedance control tab having a second inner side facing the second neck side, the first impedance control tab having a first outer side generally aligned with the first side of the main body, the second impedance control tab having a second outer side generally aligned with the second side of the main body.

8. The electrical contact of claim 1, wherein the neck is off-center relative to the main body with a first neck side of the neck being generally aligned with the first side of the main body, a second neck side of the neck facing an inner side of the impedance control tab, the impedance control tab having an outer side being generally aligned with the second side of the main body.

9. The electrical contact of claim 1, wherein the contact tail includes an opening therethrough, the neck having a first neck segment between the opening and a first outer edge of the contact tail, the neck having a second neck segment between the opening and a second outer edge of the contact tail.

10. The electrical contact of claim 1, wherein the impedance control tab is coplanar with the neck.

11. The electrical contact of claim 1, wherein the neck and the impedance control tab are coplanar with the main body.

12. The electrical contact of claim 1, wherein the neck and the impedance control tab have a tail width generally equal to a main body width of the main body between the first side and the second side.

13. The electrical contact of claim 1, wherein the mating contact includes a receptacle configured to receive a pin of the mating electrical contact.

14. The electrical contact of claim 1, wherein the mating contact includes a pin configured to be received in a socket of the mating electrical contact.

15. An electrical contact comprising:
a main body extending along a longitudinal axis between a mating end and a terminating end of the socket contact, the main body having a first side and a second side, the main body having a main body width between the first side and the second side, the main body having a front and a rear extending between the first side and the second side, the main body having a bottom between the first side and the second side;
a mating contact extending from the main body at the mating end, the mating contact including a mating interface configured for mating with a mating electrical contact; and
a contact tail positioned below the bottom of the main body, the contact tail including a foot configured to be terminated to a circuit board, the contact tail including a neck extending between the foot and the bottom of the main body, the neck having a first neck side and a second neck side, the neck having a neck width narrower than the main body width between the first side and the second side, the contact tail including an impedance control tab positioned between the bottom of the main body and the circuit board, the impedance control tab extending along the neck for impedance control of the contact tail between the main body and the circuit board;
wherein the impedance control tab being sized and positioned to balance impedance along the contact tail to a target impedance based on the impedance along the main body.

16. The electrical contact of claim 15, wherein the neck is separated from the impedance control tab by a gap, the gap allowing the neck to move independent of the impedance control tab.

17. The electrical contact of claim 15, wherein the impedance control tab extends substantially an entire height of the contact tail between the circuit board and the bottom of the main body.

18. The electrical contact of claim 15, wherein the impedance control tab is a first impedance control tab extending along a first side of the neck, the contact tail further comprising a second impedance control tab extending along a second side of the neck, the neck having a first neck side and a second neck side, the first impedance control tab having a first inner side facing the first neck side, the second impedance control tab having a second inner side facing the second neck side, the first impedance control tab having a first outer side generally aligned with the first side of the main body, the second impedance control tab having a second outer side generally aligned with the second side of the main body.

19. The electrical contact of claim 15, wherein the neck and the impedance control tab are coplanar with the main body.

20. An electrical connector comprising:
a housing having a mating end and mounting end, the mating end being mated with a mating electrical connector, the mounting end being mounted to a circuit board, the housing having contact channels between the mating end and the mounting end; and
socket contacts coupled to the housing, the socket contacts received in corresponding contact channels, each socket contact comprising:
a main body extending along a longitudinal axis between a mating end and a terminating end of the socket contact, the main body having a first side and a second side, the main body having a front and a rear extending between the first side and the second side;
a mating contact extending from the main body at the mating end, the mating contact including a mating interface configured for mating with a mating electrical contact of the mating electrical connector; and
a contact tail extending from the main body at the terminating end, the contact tail including a foot configured to be terminated to the circuit board, the contact tail including a neck extending between the foot and the main body, the neck being narrower than the main body between the first side and the second side, the contact tail including an impedance control tab extending along the neck for impedance control of the contact tail between the main body and the circuit board;
wherein the impedance control tab being sized and positioned to balance impedance along the contact tail to a target impedance based on the impedance along the main body.
